(19) United States
(12) Patent Application Publication
(10) Pub. No.: US 2023/0067661 A1
(43) Pub. Date: Mar. 2, 2023

(54) Control Unit for Controlling an Internal Combustion Engine

(71) Applicant: Hitachi Astemo, Ltd., Hitachinaka-shi, Ibaraki (JP)

(72) Inventors: Naoki YONEYA, Schwaig-Oberding (DE); Masayuki SARUWATARI, Hitachinaka-shi, Ibaraki (JP); Yoshihito YASUKAWA, Schwaig-Oberding (DE); Maung Maung AYE, Schwaig-Oberding (DE)

(21) Appl. No.: 17/792,534

(22) PCT Filed: Jan. 28, 2021
(86) PCT No.: PCT/JP2021/003028

§ 371 Date: Jul. 13, 2022

(30) Foreign Application Priority Data
Jan. 31, 2020 (DE) 10 2020 201 189.3

(51) Int. Cl. F02D 41/30; F02D 41/38; F02P 5/15

(52) U.S. Cl. CPC F02D 41/3029; F02D 41/38; F02P 5/1502; F02D 2200/0611; F02D 2200/101

(57) ABSTRACT

The present subject matter relates to a control unit for controlling an internal combustion engine, wherein the internal combustion engine includes at least one cylinder 100, at least one combustion chamber 90 within which a fuel is burned, at least one fuel injector 40, 50, at least one ignition device 60, and an oxygen determination unit 20 configured to determine the content of oxygen in the fuel, wherein the control unit 10 is configured to control the internal combustion engine based on the content of oxygen in the fuel detected by the oxygen determination unit 20.

The present subject-matter relates to a control unit which is adapted to control an internal combustion engine, an internal combustion engine controlled by a control unit, a control method and a computer program product. The technical advantages will become evident from the following disclosure and especially relate to an improvement of the operation of internal combustion engines driven by different kinds of fuel, in particular including conventional (fossil) gasoline/diesel and chemically synthesized fuels, such as “e-diesel” or “e-gasoline”, as well as mixtures thereof.
Patent Literature 1: JP 2010-060463

The need to reduce greenhouse gas emissions becomes urgent in order to meet the goals of the so-called “Paris Agreement”. The transport sector including road traffic is a considerable source of greenhouse gas emissions. In Germany, e.g., the transport sector had a share of nearly 20% of all greenhouse gas emissions in 2018. The European Union has implemented regulations, e.g., for reducing CO2 emissions of cars. At present, these regulations take into account CO2 emissions produced during the operation of a vehicle. This approach is also called “tank-to-wheel” calculation. In the so-called tank-to-wheel framework battery-electric vehicles are considered “emission-free”. However, it is immediately clear that the tank-to-wheel calculation cannot reproduce the complete picture and it neglects, e.g., CO2 emissions (and other greenhouse gases) produced during the production of the battery, the production of the vehicle itself, and the like. Therefore, new regulations which are expected for the middle of the 2020-century will use a so-called “well-to-wheel” approach in which the emissions for producing conventional diesel or gasoline, i.e. from the oil field to the tank of the vehicle, are taken into account, too. Furthermore, additional regulations are expected in the future which summarize the entire lifetime of the vehicle and its fuel, such as its production and its recycling. The latter approach is called “cradle to grave” calculation.

As mentioned above, battery-electric vehicles have an advantage under today's regulations because they could be seen as “zero emission” vehicles, which is however an incomplete view on the matter as explained above and it seems desirable to have additional options for successfully cutting greenhouse gas emissions in the transport sector. Additional options may include hydrogen driven vehicles, such as fuel cell vehicles, if the hydrogen is produced from renewable energy sources, and combustion engine driven vehicles which burn fuel chemically synthesized with the use of renewable energy sources. The latter includes so called “biofuel” which includes alcohol-based fuel generated from plants, such as cellulose, wheat, canola, algae, waste, etc., and which is already used in a 5% to 20% mixture with conventional fuel (conventional fuel stemming from fossil oil mainly), synthesized fuels, such as synthetic diesel or gasoline, and what will be “e-fuel” in the following. Patent literature 1, for example, describes the control of an internal combustion engine which uses mixtures of conventional fuel and biofuel. E-fuels can be considered climate neutral if produced from renewable energy sources. E-fuels may include chemically synthetized substances which are based on, e.g., ethers, aldehydes and the like. For example, oxymethylene ethers (OME) may be considered as e-diesel and methanol, dimethyl carbonate (DMC) or methyl formate (MeFo) may be considered as e-gasoline; it is noted that the chemical substances considered as e-fuel are not limited to the before mentioned exemplary substances. In the following, in particular, the term “e-fuel” may include each kind of chemically synthesized fuel which has a relatively high level/content of oxygen, preferably above 45% and more preferably 50% or more. The oxygen is, for example, intra-molecular oxygen (e.g. covalently) bound in the molecules of the fuel. Some further advantages of e-fuels are their low formation of CO and particulate matter (PN) when being burned whose reduction is a technical challenge of internal combustion engines burning conventional fuels.

Challenges in the context of burning e-fuels in internal combustion engines of vehicles comprise a lower energy density and a lower ignitability. Furthermore, e-fuels may be especially relevant for a transitional period until completely emission-free vehicles are established or for specific traffic scenarios and it is likely that vehicles will be refueled with different (as far as mixable) fuels. Therefore, mixtures of changing ratios of e-fuel to conventional fuel can be expected to be present in the tank. This however leads to further technical challenges in regard of controlling a stable and efficient combustion.

The here-described subject-matter addresses the above explained technical challenges and especially aims to provide a control device for an internal combustion engine as well as the internal combustion controlled by such a controller which can ensure reliable and efficient operation even if different fuel compositions of e-fuel and conventional fuel are to be burned by the combustion engine.

The above-described technical problem is solved by the subject matter according to the independent claims. Further preferred developments are described by the dependent claims.

The subject matter described herein, in particular, includes a control unit for controlling an internal combustion engine or parts of an internal combustion engine, such as valves, pistons, injectors, and the like. Most preferably it at least controls the combustion within the internal combustion engine. The internal combustion engine controlled may include at least one cylinder, at least one combustion chamber within which a fuel can be burned, at least one fuel injector, at least one ignition device, which may be, as one example, a spark plug configured to ignite an air-fuel-mixture inside the combustion chamber, and an oxygen determination unit configured to determine the of oxygen in the fuel. The oxygen determination unit may be enabled to determine a relative or an absolute amount of oxygen. The oxygen preferably may be an intra-molecular oxygen of the molecules of the fuel. The fuels being used are preferably liquid fossil/conventional fuel, such as fossil diesel or gasoline, and e-fuel, which is understood to be, preferably, a chemically synthesized fuel using renewable energy sources and having an oxygen content of 45% or even more preferably 50% or more. Specific examples of e-fuels were discussed above, especially chemically synthetized substances which are based on, e.g., ethers and aldehydes, such as DMC, DMC+ and MeFo. The fuel being burned is assumed to be either fossil fuel only, e-fuel only or a mixture of both with varying ratio so that the oxygen content of the mixture, i.e. the fuel (in the tank), varies, too.

The control unit may be configured to control the internal combustion engine based on the content of oxygen in the fuel detected by the oxygen determination unit. The term “controlling” may, as one example, include (only or in addition to further control steps) selecting and/or activating and/or carrying out a predefined operation mode or operational routine of the internal combustion engine or parts thereof.

Said controller/control unit/control device thus is able to reliably and stably control the internal combustion engine irrespective which mixture of fuel is to be burned, wherein the mixture of fuel preferably relates to gasoline/diesel mixed e-fuel and in particular the ratio of e-fuel to gasoline/diesel may change over time.

Further, in case the content of oxygen in the fuel is detected to be below a first threshold, the control unit may be configured to control the internal combustion engine such that a homogenous combustion mode is carried out. Homogenous combustion may in particular include injecting fuel during an intake stroke of the internal combustion engine (briefly: engine). Further, in case the content of oxygen in the fuel is determined to be equal to or higher than said first threshold, the control unit may be configured to control the internal combustion engine such that a stratified combustion mode is carried out. Stratified combustion shall in particular include an operation in which the injection of fuel during one combustion cycle is split and preferably at least a part of the fuel amount to be injected is injected during the compression stroke.
The above described preferred specific switching between stratified and homogenous combustion allows combining the technical advantages of the different combustion modes depending on the fuel mixture, especially depending on the ratio of e-fuel to conventional (fossil) fuel. For example, irrespective of the fuel mixture, the combustion can be carried out so as to optimize fuel consumption without increasing PN. The fuel mixture, especially the ratio between fossil fuel and e-fuel, does not need to be determined specifically, because it can be estimated based on the content of oxygen determined to be in a fuel probe. The relation is established based on the knowledge about the oxygen content of fossil fuel, especially diesel/gasoline, which has nearly no oxygen (about 2 to 4%) and about e-fuel which includes normally more than 50% of oxygen.

Further, the control unit may be configured to set or vary or modify or adapt or change, when a stratified combustion mode is carried out, an amount of fuel injected during a compression stroke of a combustion cycle of the internal combustion engine in relation/depending on the determined content of oxygen in the fuel. By doing so the combustion engine can allows operate optimally with regard to fuel consumption, PN emissions, and/or the like.

Further, if the determined content of oxygen in the fuel is equal to or higher than the first threshold and lower than or equal to a second threshold, the amount of fuel injected during a compression stroke of a combustion cycle of the internal combustion engine is increased with the higher the content of oxygen in the fuel. This may preferably include that a mixture of fossil fuel and e-fuel is analyzed with regard to its content of oxygen and that the fuel injection is adapted to the analysis results. The oxygen content detected indirectly allows determining the ratio of fossil fuel to e-fuel in the fuel mixture if the oxygen contents of the two fuels are known (which is true) and an optimal combustion setting can be applied for each kind of mixture. Setting a range between thresholds further allows an even more precise control of the combustion, e.g., by increasing the fuel injection amount during the compression stroke if in relation to an increase of oxygen detected. A stable, efficient and low-PN combustion is then achievable over all mixture ratios.

Further, in addition to the amount of fuel injected during a compression stroke of a combustion cycle of the internal combustion engine, the control unit may be configured to control at least a further engine control parameter depending on an operational condition, for example engine load, rotational speed of the engine, during a stratified combustion mode. In addition to the before discussed, the control may take into account not only the oxygen content for the control of the combustion but it may also include parameters, like engine speed, engine load, and the like, so that for different engine operation conditions plus fuel mixture a precise and tailor-fit control can be applied.

Examples of taking into account operational parameters of the engine and the oxygen content may include:
If the operational condition of the internal combustion engine is a middle rotational speed and a middle to high load, the control unit may be configured to set a higher global lambda value the higher the content of oxygen in the fuel. This, inter alia, allows optimized fuel consumption over the entire range of fuel mixtures with low PN emissions. A middle range of speed/load may for example be between 20% and 80% of the maximum values, preferably between 30% and 70% and more preferably between 40% and 60%.
Further, if the operational condition of the internal combustion engine is a low rotational speed and a high load, the control unit may be configured to set a lower degree of spark retardation the higher the content of oxygen in the fuel. A high and low range may be above 70% and below 30%, respectively. Preferably it may be above 80% and below 20%, respectively.
Further, wherein, if the operational condition of the internal combustion engine is a low rotational speed and a low load, the control unit may be configured to set a higher degree of spark retardation the higher the content of oxygen in the fuel.
Further, the control unit may be configured to apply an engine operation map with a larger area in which the stratified combustion mode is used the higher the content of oxygen in the fuel. The area may for example indicate an area within an engine map having the engine load and the engine speed plotted on two different axes, and depending on the oxygen content detected in the fuel mixture different engine maps may be used by the control unit, wherein the area for the stratified combustion mode is increased in engine maps being used for higher oxygen contents detected.
Further, the control unit may be configured to control a measurement of the content of oxygen in the fuel at least once after a refueling of fuel. This allows precise yet low-effort determination of the fuel mixture assuming that the mixture stably keeps an oxygen-level over time. Other options may include detecting/determining/measuring the oxygen content more frequently, e.g., after each start of the internal combustion engine.
Further, the control unit may be configured to obtain a measurement of the content of oxygen in the fuel by means of the oxygen determination unit, which may comprise an oxygen detector and/or a unit determining the oxygen content in the fuel from operational parameters of the internal combustion engine. An oxygen detector may detect intra-molecular oxygen by the use of THz-detection which is, e.g., described by patent literature 1 or by way of other sensors. Another option may include the estimation of the oxygen-content based on the combustion properties of the fuel mixture. Even further, the vehicle may keep the refueling history in a memory and receive an information about the fuel properties from a gas station at each refill, e.g. by wireless communication between the vehicle and the gas station or the like.
Furthermore, the control unit according may be configured to control port and/or direct injection of fuel and to control split fuel injection during intake stroke and/or compression stroke for further optimizing the combustion depending on the mixture of fuel being used/determined.
A system combining especially the internal combustion engine and the control unit is included in the subject matter described herein as well as a control method for the system which may include control of the internal combustion engine based on the content of oxygen in the fuel detected by the oxygen determination unit. Further, the control method may include further control steps which were described in connection with configurations of the control unit above and in the following.

Further, a computer program product storable in a memory comprising instructions which, when carried out by a computer, cause the computer to perform the control method is claimed.

Summarizing, burning mixtures of fossil fuel and e-fuels for powering internal combustion engines of vehicles might add an option for reducing greenhouse gas emissions, especially in a transitional period during which no options for completely emission-free fuels/vehicles are available for the mass market. The technical challenges which arise from burning these mixtures and in view of optimized fuel consumption, PN emission reduction, and the like are neatly addressed by the herein described and claimed subject matter.

In the following the subject matter will be further explained based on at least one preferential example with reference to the attached exemplary and schematic drawings, wherein:

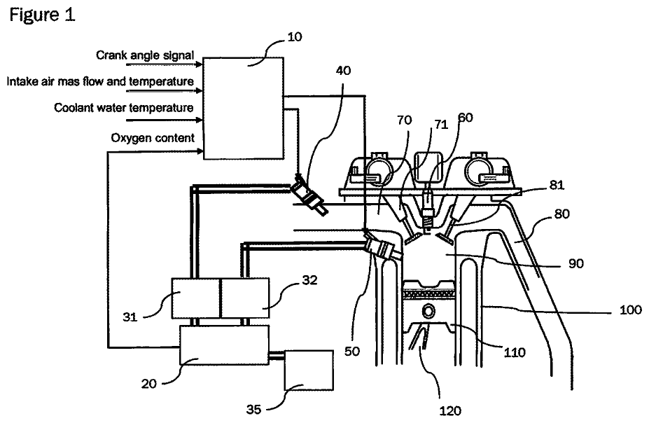

FIG. 1 depicts a schematic view of a cylinder of an internal combustion engine;

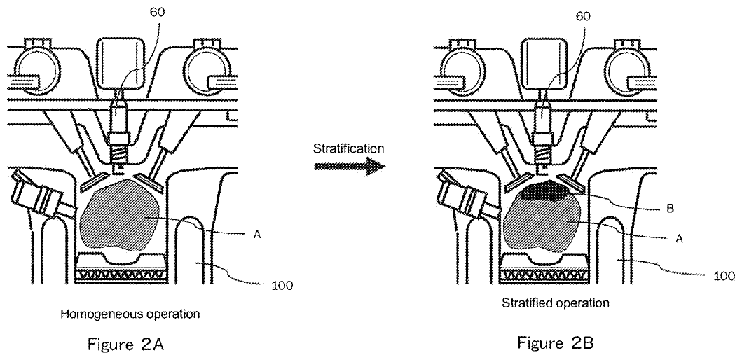

FIGS. 2A-2B depict a schematic view of a combustion chamber of the cylinder during different combustion control modes;

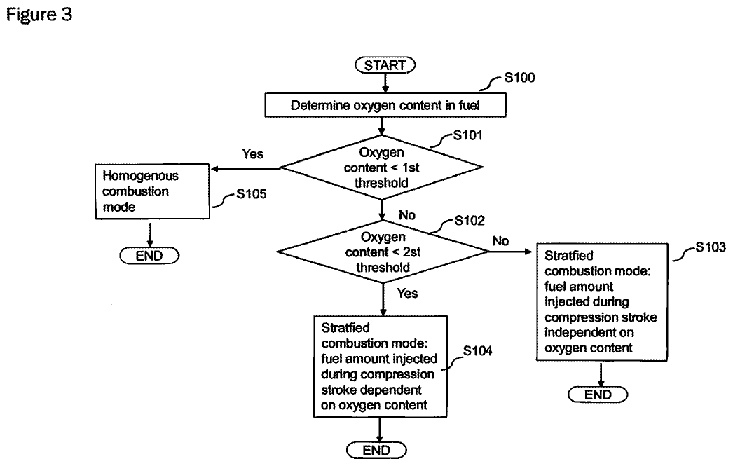

FIG. 3 shows a control method;

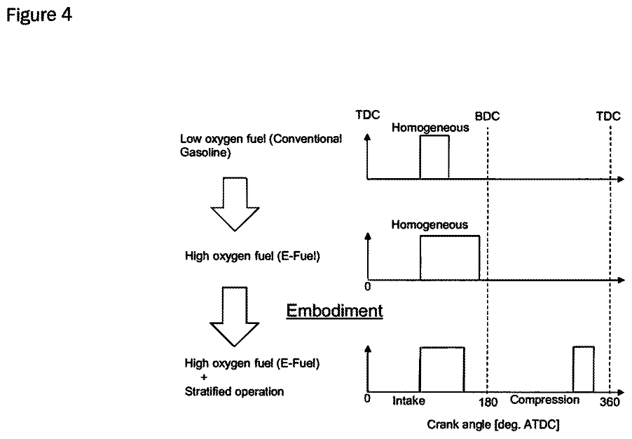

FIG. 4 shows a basic principle of the claimed subject matter compared to conventional combustion control schemes;

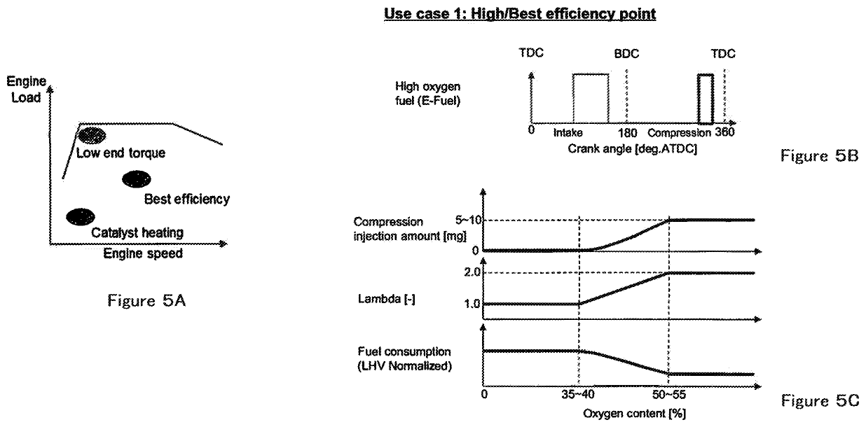

FIGS. 5A-5C show a use case 1;

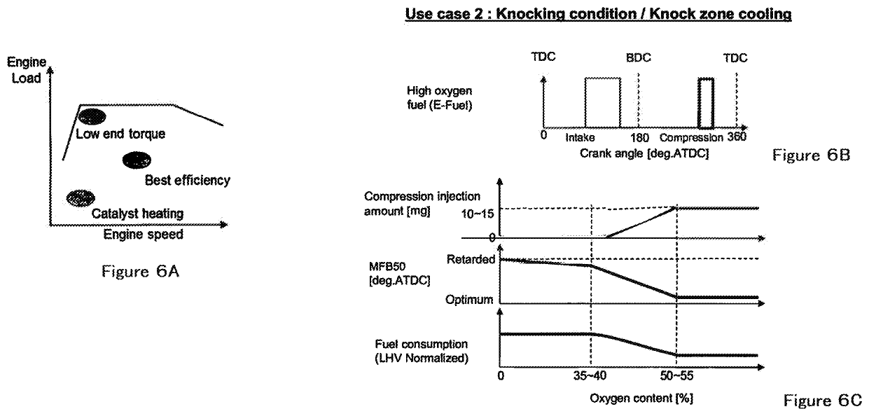

FIGS. 6A-6C show a use case 2;

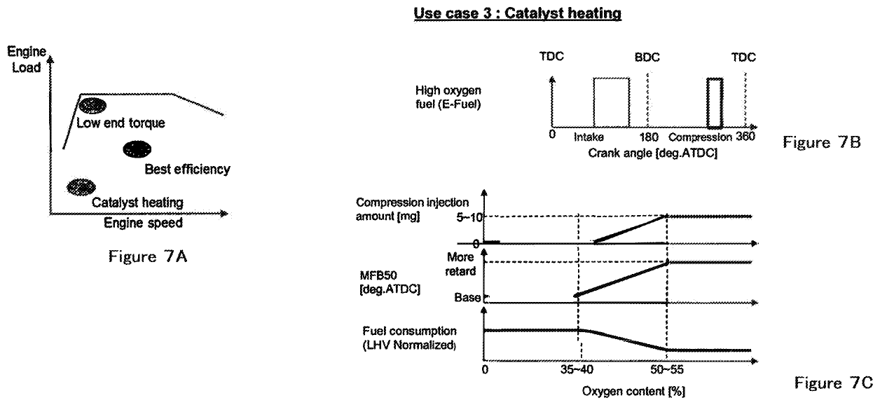

FIGS. 7A-7C show a use case 3.

FIG. 1 schematically shows a cylinder 100 of an otherwise unspecified internal combustion engine (not shown) which may have one or more than one cylinder 100. The engine may, for example, have two, three, four, six, eight or less/more cylinders. The engine comprises at least one piston 110 driven via a connecting rod 120 by a crankshaft (not depicted) for repeated reciprocal movement in the cylinder 100 to define the combustion chamber 90 therein.

An (air) intake port 70 with an intake valve 71 as well as an exhaust port 80 with an exhaust valve 81 are connected to the combustion chamber 90. Ambient air is drawn into the combustion chamber 90 through the intake port 70. Exhaust gases are discharged from the combustion chamber 90 via the exhaust port 80. An ignition device 60 comprising a spark plug is provided; optionally a prechamber fuel injector and a prechamber (both not shown) may be optionally attached to the internal combustion engine.

Furthermore, a direct fuel injector 50, or at least parts thereof, is joined to the inside of the combustion chamber 90 which allows to inject fuel therein. The direct fuel injector 50 may preferably be an electrohydraulic fuel injector or a piezoelectric fuel injector. Additionally, a port fuel 40 injector may be connected to the intake port 70 of the cylinder 100. The high-pressure fuel supply of the direct fuel injector 50 and the high- or low-pressure fuel supply of the port fuel injector 40 are not depicted. The fuel injection may be either performed by the direct main fuel injector 50 or the port main fuel injector 40 or may be divided between both injectors.

A control unit 10 which may in particular control the ignition device(s) is further shown in FIG. 1. The control unit 10 is electrically connected to the ignition device 60, the direct fuel injector 50 and/or the port fuel injector 40 and may be configured to control the multiple units/injectors/actuators. The control unit 10 may be, for example, the engine control unit (ECU) or may be a part thereof. The control unit 10 may be any other control unit, and signal line connections between the control unit 10 and the controlled units may differ from the example of FIG. 1. For example, there may be a plurality of control units 10 which may control subgroups of the controlled units, e.g. one control unit 10 may control only the ignition device 60, another control unit 10 may control only fuel injectors and so on. Even further, if there is a plurality of control units 10, these control units 10 may be interconnected with each other hierarchically or in another way. Alternatively, there may be one single control unit 10 which includes all the control functions of the multiple actuators of the internal combustion engine.

FIG. 1 further shows electrical connections between parts of the internal combustion engine and some signals input/output to the each unit. Specifically, in the example of FIG. 1, an oxygen detector or oxygen determination unit 20 is shown that is fluidic connected with a fuel tank 35 and the injectors 40, 50. A low pressure pump 31 connects the oxygen determination unit 20 with the port fuel injector 40 and a high pressure pump 32 connections the oxygen determination unit 20 with the direct fuel injector 50 in the example of FIG. 1. Preferably, as shown, the oxygen determination unit 20 is provided downstream of the tank 35 and upstream of the before described pumps 31, 32. The fuel, before it is supplied to the injectors 40, 50, is analyzed by the oxygen determination unit 20 with regard to the absolute or relative amount of oxygen contained in the fuel. For example, the determination may return the result that a certain percentage between 0% and 100% of e-fuel is contained in the fuel. The determination of the amount of e-fuel in the fuel mixture can be performed by using the known oxygen contents of the fuels included in the mixture. However, it is also sufficient for the herein described control to determine the oxygen content of the fuel mixture only, i.e. without determining the ratio of fossil fuel and e-fuel in the mixture.

Furthermore, FIG. 1 shows signal connection lines. There is one signal connection line between the oxygen determination unit 20 and the control unit 10 for providing information to the control unit 10 about the determined amount/ratio of oxygen in the fuel. Furthermore, examples of further signals input to the control 10 and used for controlling the internal combustion engine/the combustion are depicted, such as crank angle signal, intake air mass flow and intake air temperature, coolant water temperature, and the like. The control unit 10 may output, inter alia, control signals to the fuel injectors 40, 50.

In the depicted example of FIG. 1 the control unit 10 is enabled to receive information about the amount of oxygen in the fuel or the ratio of e-fuel to fossil fuel which is to be burned in the combustion chamber 90. The measurement/determination of oxygen does not necessarily has to be carried out each time fuel is pumped to the injectors 40, 50, however, it is one option. Another preferred option may include that a sensor (not shown) connected to the tank 35 detects a process of refueling so that only immediately after a refill operation the oxygen amount is determined. Further, said sensor may not be needed and the control unit 10 may receive a signal instead which indicated a refill operation, e.g., based on the level of fuel in the tank or the like. Further options may include that the oxygen amount/ratio is determined each time after the engine was newly started.

The oxygen determination unit 20 may, for example, use a sensor enabled to detect/measure/determine the content of oxygen, preferably intra-molecular oxygen, in the fuel. One technique is to use THz-electromagnetic waves and respective transducers, such as described by Patent Literature 1. Furthermore, besides using sensors for detecting the oxygen content, it may also be possible to detect the combustion conditions and to determine the oxygen content and/or the fuel mixture therefrom, e.g. the fuel properties of fossil fuel and e-fuel are distinctively different so that the combustion conditions change if the mixture changes. This can be detected and, e.g., a map stored in the control unit 10 or elsewhere in the vehicle can be used to determine the oxygen content. Furthermore, gas stations may deliver the information about the fuel refilled at ach refill to the vehicle by way of mobile communication of the like between the vehicle/control unit 10 and the gas station which may allow to determine the oxygen content based on keeping a refill history.

FIG. 2 shows in FIG. 2A a typical example of a combustion pattern within the combustion chamber 90 when a homogenous combustion is carried out. The fuel is distributed rather homogenously after its injection into the combustion chamber 90 (see zone A in FIG. 2A). FIG. 2B shows a typical example of a combustion pattern within the combustion chamber 90 when a stratified combustion is carried out. The fuel is distributed in a stratified manner after the injections (see exemplary zones A and B within the combustion chamber 90 in FIG. 2B). The stratification may be achieved, e.g., by splitting injections into multiple injections and/or using the direct and port injector 40, 50 in a combined manner. One possibility which is preferably used in the present case includes splitting the total amount of fuel for one combustion cycle into at least two injections, wherein one injection is carried out during the compression stroke, especially preferably closer to the top dead center (TDC) than to the bottom dead center (BDC). More specific application scenarios and examples will be described in the connection with the following Figures.

FIG. 3 shows a preferred example of the herein described control method and the control for which the control unit is adapted to carry it out, respectfully. In a first step S100 the oxygen content in the fuel is determined. The determination may be used, in an optional further step, determining a ratio of e-fuel compared to fossil fuel.

If the determined content of oxygen is found to be below a first threshold (S101), which may be set in a range of 10% to 45% oxygen in the fuel, preferably set in a range of 20 to 45% and especially preferably set to be between 35% and 40%, the homogenous combustion mode(s) is/are carried out by the control unit 10. Otherwise, in a Step 102, it is checked whether the oxygen content is below or above a second threshold which is preferably set above 45% and especially preferably above 50%. Preferably the second threshold is set lower than 60% and especially preferably in a range from 50% to 55%. Most preferably, the 2^{nd} threshold is set around (within few percent points) the value which is expected for pure e-fuel in the tank. If the determined content of oxygen is above the second threshold, the stratified combustion mode is carried out (S103), wherein the amount of fuel injected during the compression mode is not dependent on the content of oxygen in the fuel. Otherwise, if it is found that the oxygen content is below the second threshold (S102), the stratified combustion mode is carried out (S104), wherein the amount of fuel injected during the compression mode depends on the content of oxygen in the fuel. Preferably, in the latter case, the amount of fuel injected during the compression stroke has a linearly increasing relation to an increasing level of content of oxygen. If step S101 returns that the oxygen content is below the first threshold, a homogenous combustion mode is carried out (S105).

FIGS. 4 to 7 show specific examples/use cases for control modes which are however not limiting for the herein described subject matter and further examples shall be considered encompassed by the herein described subject matter. FIG. 4 shows a basic principle underlying the subject matter. Conventional/fossil fuel, such as gasoline, can be combusted by a single injection of fuel during the intake stroke. If an e-fuel, which shall especially be construed as a high oxygen content fuel as discussed above, is to be burned, the injection amount is increased due to the reduced energy density of e-fuels. The herein described subject matter and the above described examples in particular apply a control concept during which a stratified operation is applied if the amount of e-fuel, determined via the oxygen content of the fuel, is relatively high. FIGS. 5 to 7 then show specific examples of application scenarios/use cases and they show especially examples for the control of the internal combustion engine according to which not only the oxygen content in the fuel is used for selecting a control mode of the engine but an engine condition, too.

FIGS. 5A, 6A and 7A each show an engine map with the engine load on the vertical axis and the engine speed on the horizontal axis as well as three regions for three exemplary use cases 1 to 3 which are further depicted in the FIGS. 5B,c; 6B,c and 7B,c. FIGS. 5B and 5C show the use case in which the engine operates in a region of the engine map which allow a control with regard to achieving the best/high efficiency. The region of high/best efficiency control is located in a mid-range of engine load and engine speed. The mid-range preferably is located in between 20% and 80%, more preferably between 30% and 70%, more preferably between 40% and 60% and very preferably between 45% and 55%. As soon as the oxygen content in the fuel is found to be higher than the 1^{st} threshold, which is shown in FIG. 5C between 35% and 40% of oxygen content in the fuel, the stratified operation with at least one fuel injection during the compression stroke (see FIG. 5B) is started. The compression-stroke fuel injection is preferably smaller with regard to the amount of fuel injected than the injection during the intake stroke. Very preferably, the compression-stroke injection is carried out briefly before TDC, e.g. after 300° of the crank angle.

Controlled parameters and the specific control thereof being carried out for the use case 1, which is based on the oxygen content in the fuel, are depicted by FIG. 5C. The Figure shows that below the first threshold, the indicated parameters are kept constant irrespective of the exact value of the content of oxygen in the fuel. The parameters of specific interest in use case 1 are the compression-stroke injection amount (indicated in [mg] in the FIG. 5C), the lambda value and the fuel consumption (LHV normalized). In the region of oxygen content values below the first threshold homogenous combustion is carried out and the amount of fuel injected during the compression stroke is kept constantly at zero, while lambda is kept constantly at 1.0. If the oxygen content in the fuel is however found to fall in a range between the 1^{st} threshold and the 2^{nd} threshold, the compression-stroke injection amount is increased as well as the lambda value with increasing oxygen content values in the fuel. FIG. 5C shows approximately a linear relation, however, other correlations may be applied as well. Starting with the 2^{nd} threshold, which is located in between 50% to 55%, as an example, in FIG. 5C, the compression-stroke injection amount and the lambda values are both maximized and are kept constant over further increasing oxygen content values. The exemplary values shown in the FIG. 5C are between 5 to 10 mg fuel injection during the compression-stroke and 2.0 lambda. The fuel consumption can be optimized by the above discussed control which is also shown by the decreasing trend in the lowest graph of FIG. 5C.

Use case 2, which is shown in FIG. 6, shows knocking condition or knock zone cooling operations. The engine speed, as shown by FIG. 6A, is relatively low, e.g. below 40% or lower and the engine load is near to the maximum, e.g. above 80% or higher. Parameters of especial interest for the control of use case 2 are again the compression-stroke injection amount in FIG. 6C and the MFB50 value. One can see from FIG. 6C that the stratified operation, see FIG. 6B, is applied for e-fuel amounts of above the 1^{st} threshold (which is shown to be the same as in FIG. 5C). The compression-stroke injection amount is again increased with increasing content of oxygen in the fuel until the 2^{nd} threshold. However, the ignition is shifted from the retarded side to the optimum, as the middle graph of FIG. 6C indicates. The fuel consumption can be improved again with increasing amounts of e-fuel in the fuel.

Further, use case 3, which relates to a catalyst heating scenario in which the engine speed is very low, e.g. below 20% or 30%, and the engine load is very low, e.g., below 20% or 30%, too. In this case the same parameters are used and shown in FIG. 7C, however, the ignition is shifted to the more retarded side for increasing values of oxygen in the fuel until the 2^{nd} threshold.

A control unit, a control method and a related computer program product are described which allow using e-fuels in internal combustion engines wherein the control is such optimized that low fuel consumption is achieved and low PN emissions.

In general, all features of the different embodiments, aspects and examples, which are described herein, and which are shown by the Figures, may be combined either in part or in whole. The herein described subject-matter shall also entail these combinations as far as it is apparent to the person skilled in the art without applying inventive activity.

It should also be noted that the description and drawings merely illustrate the principles of the proposed methods, devices and systems. It will thus be appreciated that those skilled in the art will be able to devise various arrangements that, although not explicitly described or shown herein, embody the principles of the claimed subject matter and are included within its spirit and scope.

Although the citation of other claims in dependent claims is a single claim citation for the sake of clarity in the dependent claims, the invention includes the form in which multiple claims are cited in dependent claims (multi-claim dependent claims) and the form in which multiple multi-claim dependent claims are cited in dependent claims.

### REFERENCE SIGN LIST

10 Control Unit
20 Oxygen Determination Unit
31, 32 Pump
35 tank
40 port fuel injector
50 direct fuel injector
60 ignition device
70 intake port
71 intake valve
80 exhaust port
81 exhaust valve
90 combustion chamber
100 cylinder
110 piston
120 connecting rod

1. Control unit for controlling an internal combustion engine, wherein the internal combustion engine includes at least one cylinder, at least one combustion chamber within which a fuel is burned, at least one fuel injector, at least one ignition device, and an oxygen determination unit configured to determine the content of oxygen in the fuel, wherein
the control unit is configured to control the internal combustion engine based on the content of oxygen in the fuel detected by the oxygen determination unit.

2. Control unit according to claim 1, wherein, if the content of oxygen in the fuel is below a first threshold, the control unit is configured to control the internal combustion engine such that an homogenous combustion mode is carried out, and, if the content of oxygen in the fuel is equal to or higher than said first threshold, to control the internal combustion engine such that a stratified combustion mode is carried out.

3. Control unit according to claim 2, wherein the control unit is configured to set, when a stratified combustion mode is carried out, an amount of fuel injected during a compression stroke of a combustion cycle of the internal combustion engine based on the content of oxygen in the fuel.

4. Control unit according to claim 2, wherein, if the content of oxygen in the fuel is equal to or higher than the first threshold and lower than or equal to a second threshold, the amount of fuel injected during a compression stroke of one combustion cycle of the internal combustion engine is set higher the higher the content of oxygen in the fuel.

5. Control unit according to claim 4, wherein, in addition to the amount of fuel injected during a compression stroke of a combustion cycle of the internal combustion engine, the control unit is configured to control at least a further engine control parameter depending on an operational condition of the internal combustion engine during a stratified combustion mode.

6. Control unit according to claim 5, wherein, if the operational condition of the internal combustion engine is a middle rotational speed and a middle to high load, the control unit is configured to set a higher global lambda value the higher the content of oxygen in the fuel.

7. Control unit according to claim 5, wherein, if the operational condition of the internal combustion engine is a low rotational speed and a high load, the control unit is configured to set a lower degree of spark retardation the higher the content of oxygen in the fuel.

8. Control unit according to claim 5, wherein, if the operational condition of the internal combustion engine is a low rotational speed and a low load, the control unit is configured to set a higher degree of spark retardation the higher the content of oxygen in the fuel.

9. Control unit according to claim 1, wherein the control unit is configured to apply an engine operation map with a larger area in which the stratified combustion mode is used the higher the content of oxygen in the fuel.

10. Control unit according to claim 1, wherein the control unit is configured to control a measurement of the content of oxygen in the fuel at least once after a refueling of fuel.

11. Control unit according to claim 1, wherein the control unit is configured to obtain a measurement of the content of oxygen in the fuel by means of the oxygen determination unit, which comprises an oxygen detector and/or a unit determining the oxygen content in the fuel from operational parameters of the internal combustion engine.

12. System including a control unit according to claim 1 and an internal combustion engine which includes at least one cylinder, at least one combustion chamber within which a fuel is burned, at least one fuel injector, at least one ignition device, and an oxygen determination unit configured to determine the content of oxygen in the fuel.

13. A control method for the system according to claim 12, performing control of the internal combustion engine based on the content of oxygen in the fuel detected by the oxygen determination unit.

14. Computer program product storable in a memory comprising instructions which, when carried out by a computer, cause the computer to perform the control method according to claim 13.
